(19) United States
(12) Patent Application Publication
(10) Pub. No.: US 2005/0135915 A1
(43) Pub. Date: Jun. 23, 2005

(54) Pipe-handling boom and method of use thereof

(76) Inventor: Charlie Hall, Bartow, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/006,445

(22) Filed: Dec. 6, 2004

Related U.S. Application Data
(60) Provisional application No. 60/527,414, filed on Dec. 5, 2003.

(51) Int. Cl. B66C 1/00

(52) U.S. Cl. 414/739

(57) ABSTRACT

A pipe-handling boom, and method of use thereof, adapted to mount onto an excavator boom, wherein an excavator operator may utilize the pipe-handling boom while the excavator is disposed atop the bridge deck. The pipe-handling boom generally comprises a multi-directional and fully rotational grapple in cooperative communication with a telescopically-adjustable boom arm, wherein the grapple mimics human hand and wrist movements, thereby providing the operator with the ability to grasp and lift a selected length of pipe, and, to further maneuver, cant, tilt, rotate or otherwise positionally-manipulate the pipe relative to the telescopically-adjustable boom arm. The boom arm, in cooperation with the grapple, enables the excavator/boom operator to guide the pipe over the side of the bridge deck, positionally extend the pipe therebeneath, and thus, lay the pipe within and between selected girders, T-beams, or other areas, disposed on the underside of the bridge deck.

### CROSS-REFERENCE AND PRIORITY CLAIM TO RELATED APPLICATIONS

To the fullest extent permitted by law, the present nonprovisional patent application claims priority to and the full benefit of provisional patent application entitled “PIPE HANDLING BOOM”, filed on Dec. 5, 2003, having assigned Ser. No. 60/527,414.

### TECHNICAL FIELD

The present invention relates generally to heavy construction equipment, and more specifically to a pipe-handling boom adapted to grasp, lift, maneuver, position, guide and lay pipe within a selected area. The present invention is particularly suitable for positioning and laying pipe within and between selected girders or T-beams disposed on the underside of a bridge deck.

### BACKGROUND OF THE INVENTION

Lifting, positioning, laying and securing pipe (i.e., 24-inch diametered water pipe, and the like) to the underside of a bridge is an arduous and time-consuming process, often requiring a significant amount of man-hours and complex machinery.

Due to the sheer height between a typical bridge main span and the earthen ground or water surface below, attempting to lift, reach, position and maneuver such pipe between girders or T-beams disposed on the underside of the bridge deck can prove a daunting task, especially in view of traditional methods utilizing conventional under-deck construction machinery and/or cranes affixed to a barge.

Therefore, it is readily apparent that there is a need for a pipe-handling boom adapted to mount onto an excavator, wherein an excavator operator may utilize the pipe-handling boom while the excavator is disposed atop the bridge deck. The pipe-handling boom provides the operator with the ability to grasp and lift a selected length of pipe, and to further maneuver, position and guide the pipe over the side of the bridge deck and lay the pipe within and between selected girders, I-beams, or other areas, disposed on the underside of the bridge deck.

### BRIEF SUMMARY OF THE INVENTION

Briefly described, in a preferred embodiment, the present invention overcomes the above-mentioned disadvantages and meets the recognized need for such a device by providing a pipe-handling boom, and method of use thereof, adapted to mount onto an excavator boom, wherein an excavator operator may utilize the pipe-handling boom while the excavator is disposed atop the bridge deck. The pipe-handling boom generally comprises a multi-directional and fully rotational grapple in cooperative communication with a telescopically-adjustable boom arm, wherein the grapple mimics human hand and wrist movements, thereby providing the operator with the ability to grasp and lift a selected length of pipe, and, to further maneuver, cant, tilt, rotate or otherwise positionally-manipulate the pipe relative to the telescopically-adjustable boom arm. The boom arm, in cooperation with the grapple, enables the excavator/boom operator to guide the pipe over the side of the bridge deck, positionally extend the pipe therebeneath, and thus, lay the pipe within and between selected girders, T-beams, or other areas, disposed on the underside of the bridge deck.

According to its major aspects and broadly stated, the present invention in its preferred form is a pipe-handling boom comprising a telescopically-adjustable boom arm, and a multi-directional and fully rotational grapple.

More specifically, the present invention is a pipe-handling boom, wherein a telescopically adjustable boom arm is mounted to an excavator boom adapted to support and hydraulically control the telescopic extension and retraction thereof. As more fully described below, an excavator operator may utilize the pipe-handling boom while the excavator is disposed atop a bridge deck, or at least a portion thereof, or any other structural span; thus, avoiding the disadvantages and delays associated with conventional methodologies of underdeck bridge construction.

Preferably disposed at the distal end of the boom arm is a multi-directional and fully rotational grapple, wherein the grapple comprises clamp jaws for securely grasping a pipe or similar object, and wherein the clamp jaws comprise rubber gripping pads to enhance frictional contact and grasping of a pipe or other selected object therebetween. Moreover, through a series of hydraulic cylinders, pivoting joints, rotational drives and bearing surfaces, the grapple is able to effectively mimic human hand and wrist movements. As such, the grapple may be fully rotated 360 degrees about the distal end of the boom arm, thereby facilitating maneuverability and positioning of a pipe carried between the clamp jaws; pivot into an angle perpendicular to the boom arm; and further pivot, cant or otherwise tilt the clamp jaws from side-to-side and into a desired angle relative to the boom arm, thus, further facilitating maneuverability and positional manipulation of a pipe carried between the clamp jaws. The distal ends of each clamp jaw further preferably provide slotted areas for the purpose of receiving and grasping the edges of conventional T-beams, or the like; thereby, enabling movement, positioning and placement of same in a desired location.

Upon grasping and lifting a pipe via the grapple, the operator preferably maneuvers the pipe-handling boom to position and guide the pipe over the side of the bridge deck. Thereafter, the operator may selectively telescopically extend the boom arm out into the underside of the bridge deck, thus facilitating guidance and positioning of the pipe thereunder. Once the pipe is positioned proximal to its desired position, the operator preferably actuates the grapple so as to further maneuver, rotate, cant, tilt and/or otherwise positionally manipulate the pipe, thus setting and/or locking the pipe into place either between selected girders or T-beams, or other support structures disposed on the underside of the bridge deck.

To facilitate the operator's pipe handling and laying process, the pipe-handling boom of the present invention further incorporates a plurality of strategically positioned cameras that relay real-time visual feedback to television monitors located within the operator's cab of the excavator. As such, the operator is able to visually perceive or view all operations and movements of the pipe-handling boom when extended under the bridge deck; thus, facilitating accuracy of the pipe laying process. Additionally, spotters and/or other crewmen situated below the bridge deck may provide instructional body language readily visually perceivable through the cameras and associated television monitors, and/or through audio communications relayed via suitable transmitters and receivers.

Accordingly, a feature and advantage of the present invention is its ability to be mounted onto an excavator boom and utilized while the excavator is disposed atop a bridge deck.

Another feature and advantage of the present invention is its telescopically-adjustable arm capable of reaching the underside of a bridge deck.

Still another feature and advantage of the present invention is its multi-directional and fully rotational grapple, designed to mimic human hand and wrist movements; thereby, providing the operator with the ability to grasp and lift a selected length of pipe, and, to further maneuver, cant, tilt, rotate or otherwise positionally-manipulate the pipe relative to the telescopically-adjustable boom arm.

Yet another feature and advantage of the present invention is its ability to position, lay and secure pipe to the underside of a bridge deck in a fraction of the time required through traditional pipe laying processes and equipment.

A further feature and advantage of the present invention is its incorporation of video cameras to permit the relay of real-time visual feedback to television monitors located within the operator's cab of the excavator; thus, enabling the excavator operator to view the underside of the bridge deck.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a side view of a pipe-handling boom according to a preferred embodiment of the present invention, shown in use;

FIG. 2 is a side view of a grapple of a pipe-handling boom according to a preferred embodiment of the present invention, shown in use;

FIG. 3A is a perspective view of a grapple of a pipe-handling boom according to a preferred embodiment of the present invention, shown in use;

FIG. 3B is a perspective view of a grapple of a pipe-handling boom according to a preferred embodiment of the present invention, shown in use;

FIG. 3C is a perspective view of a grapple of a pipe-handling boom according to a preferred embodiment of the present invention, shown in use;

FIG. 3D is a perspective view of a grapple of a pipe-handling boom according to a preferred embodiment of the present invention, shown in use;

FIG. 3E is a perspective view of a grapple of a pipe-handling boom according to a preferred embodiment of the present invention, shown in use;

FIG. 4 is a side view of a portion of a telescopically-adjustable boom arm of a pipe-handling boom according to a preferred embodiment of the present invention;

FIG. 5 is a perspective view of a portion of a telescopically-adjustable boom arm of a pipe-handling boom according to a preferred embodiment of the present invention;

FIG. 6 is a side view of a pipe-handling boom according to a preferred embodiment of the present invention, shown in use; and,

FIG. 7 is a perspective view of a grapple of a pipe-handling boom according to a preferred embodiment of the present invention, shown in use.

### DETAILED DESCRIPTION OF THE PREFERRED AND SELECTED ALTERNATIVE EMBODIMENTS

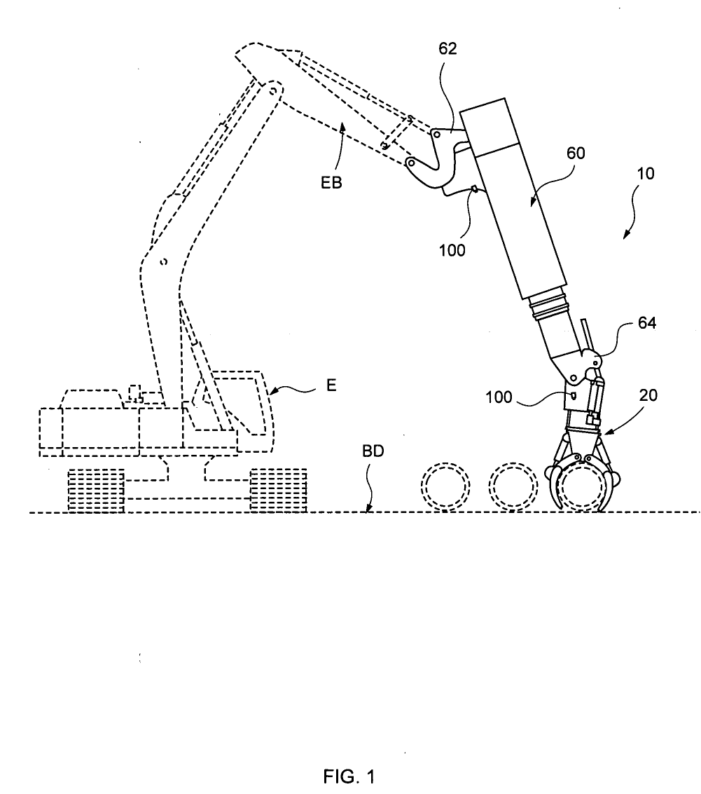

In describing the preferred and selected alternate embodiments of the present invention, as illustrated in FIGS. 1-7, specific terminology is employed for the sake of clarity. The invention, however, is not intended to be limited to the specific terminology so selected, and it is to be understood that each specific element includes all technical equivalents that operate in a similar manner to accomplish similar functions.

Referring generally now to FIGS. 1-7, the present invention in a preferred embodiment is a pipe-handling boom 10, generally comprising multi-directional and fully rotational grapple 20, telescopically-adjustable boom arm 60, and camera assemblies 100. Proximal end 62 of telescopically-adjustable boom arm 60 is preferably pivotally mounted and hydraulically-coupled to excavator boom EB of excavator E, wherein distal end 64 of boom arm 60 is preferably pivotally and hydraulically coupled to grapple 20. Accordingly, excavator E is preferably adapted to support and hydraulically control telescopic extension and retraction of boom arm 60, and to further provide hydraulic power for the operation grapple 60. Moreover, and as more fully described below, excavator E with pipe-handling boom 10 of the present invention is preferably situated atop bridge deck BD during the entire pipe laying process.

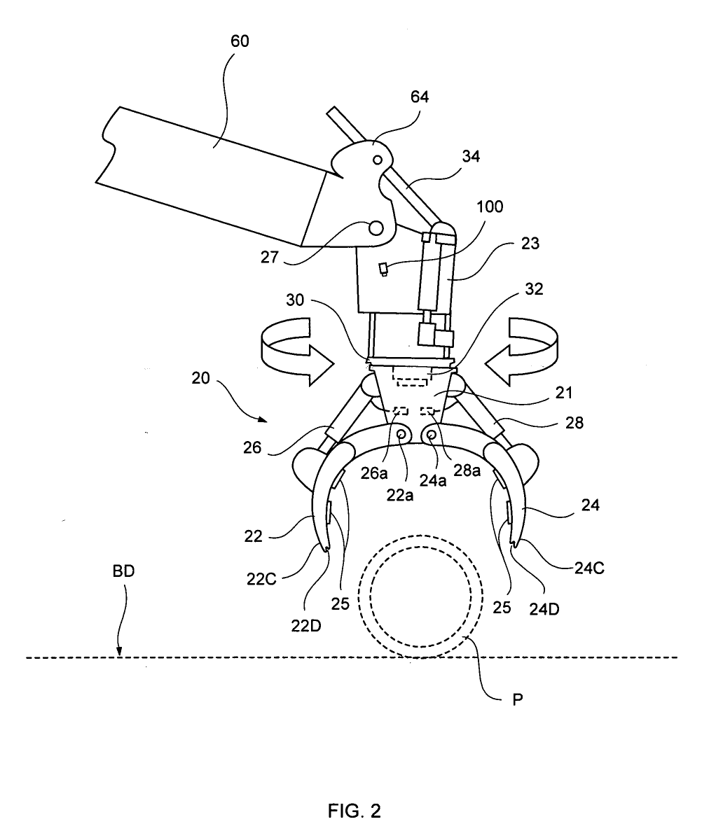

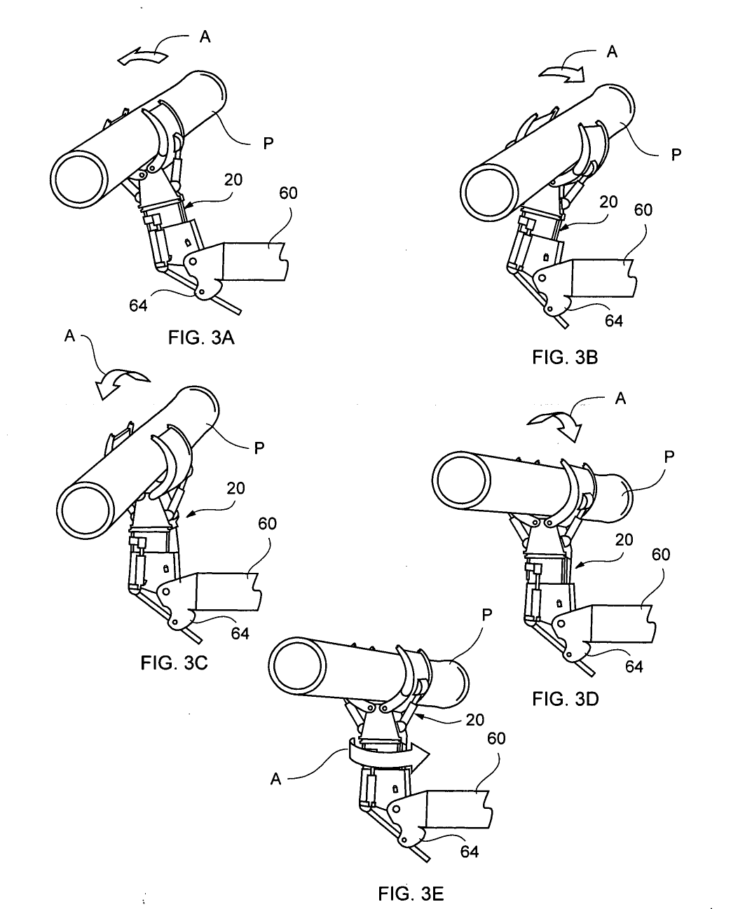

Referring now more specifically to FIGS. 2-3E, grapple 20 preferably comprises clamp jaws 22, 24 pivotally coupled to hub 21 at proximal ends 22a, 24a, respectively, thereof. Clamp jaws 22, 24 are preferably generally arcuate-shaped so as to facilitate the secure grasping of cylindrical cross-sectional-shaped pipes P or other similar objects; however, it should be recognized that clamp jaws 22, 24 may comprise alternate structural configurations, shapes and/or dimensions so as to appropriately and securely grasp objects comprising cylindrical or alternate cross-sectional shapes.

Clamp jaw hydraulic cylinders 26, 28 preferably pivotally extend from hub 21 and terminate in pivotal communication with respective clamp jaws 22, 24. Accordingly, hydraulic cylinders 26, 28 preferably actuate clamp jaws 22, 24, respectively, and thereby enable the clamping or release of pipe P therebetween. Further, to ensure the secure clamping of pipe P between clamp jaws 22, 24, hydraulic cylinders 26, 28 are preferably releasably locked via hydraulic locking valves 26a, 28a, respectively, once clamp jaws 22, 24 are securely positioned and pressed against pipe P. Additionally, inner surfaces 22b, 24b of respective clamp jaws 22, 24 preferably each comprise rubber gripping pads 25 to enhance frictional contact and grasping of pipe P or other selected objects between clamp jaws 22, 24. As more fully described below, hydraulic cylinders 26, 28 further enable clamp jaws 22, 24 to cant, tilt, or otherwise pivot into a desired angle relative to hub 21 and, thereby, assist in the overall positional-manipulation of pipe P retained between clamp jaws 22, 24.

Preferably, rotational bearings 30 and hydraulically-actuated rotational drive 32 of hub 21 enable grapple 20 to rotate 360 degrees about distal end 64 of boom arm 20; thereby, further facilitating maneuverability and positioning of pipe P carried between clamp jaws 22, 24. Additionally, base 23 of grapple 20 is pivotally coupled to distal end 64 of boom arm 20 via pivot axle 27, wherein pivot axle 27, in conjunction with grapple hydraulic tilt cylinder 34, preferably enables grapple 20 to pivot into any of a plurality of angles between zero and ninety degrees (0-90 degrees) perpendicular to telescopically-adjustable boom arm 60; thus, still further facilitating overall maneuverability and positional-manipulation of pipe P carried between clamp jaws 22, 24. Indeed, such pivotal movement of grapple 20 into any of a plurality of angles between zero and ninety degrees (0-90 degrees) relative to boom arm 60 becomes especially important during the pipe positioning, laying and mounting stage implemented on the underside of bridge deck BD, as more fully described below. It should be recognized that grapple 20 could be manufactured so as to enable pivotal movement of same up to and through ninety degrees (90 degrees).

Accordingly, and as best illustrated in FIGS. 3A-3E with specific reference to directional arrows A, through cooperative interaction of clamp jaws 22, 24, clamp jaw hydraulic cylinders 26, 28, rotational bearings 30, rotational drive 32, pivot axle 27, grapple hydraulic tilt cylinder 34, and all associated pivot joints thereof, grapple 20 is able to effectively mimic human hand and wrist movements, and bring pipe P into a variety of positional permutations to facilitate desired handling, positioning and laying of pipe P within or between the underside structures of bridge deck BD. That is, grapple 20 may be fully rotated 360 degrees; pivot into any of a plurality of angles between zero and ninety degrees (0-90 degrees) perpendicular to boom arm 60; and further, via hydraulic cylinders 26, 28, pivot, cant or otherwise tilt clamp jaws 22, 24 from side-to-side and into a desired angle relative to hub 21 of grapple 20.

As an additional structural advantage, distal ends 22c, 24c of clamp jaws 22, 24, respectively, further preferably comprise slotted or grooved areas 22d, 24d, respectively, for the purpose of receiving and grasping the edges of conventional T-beams, or the like, for movement, positioning and placement of same within or between the underside structures of bridge deck BD, or other selected locations.

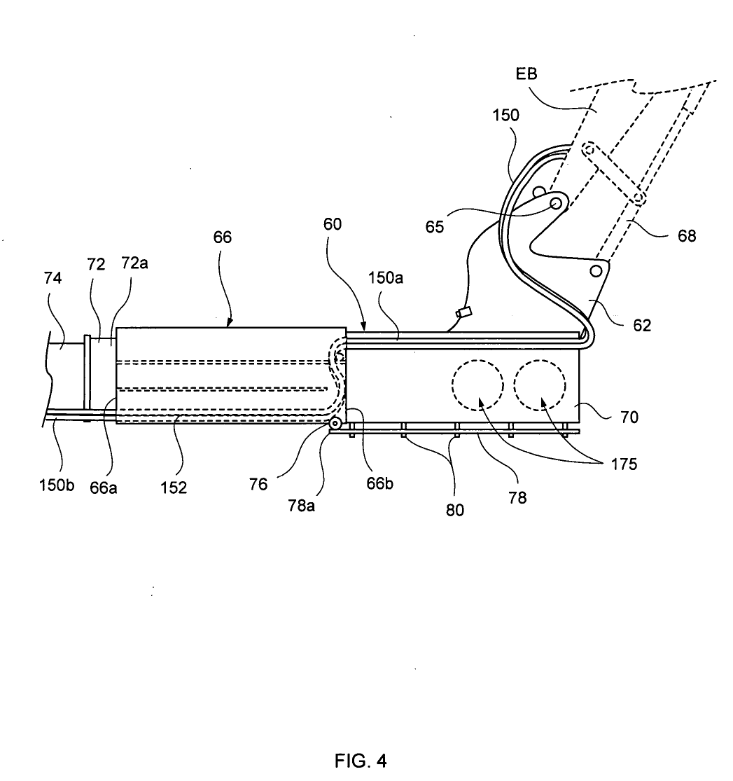

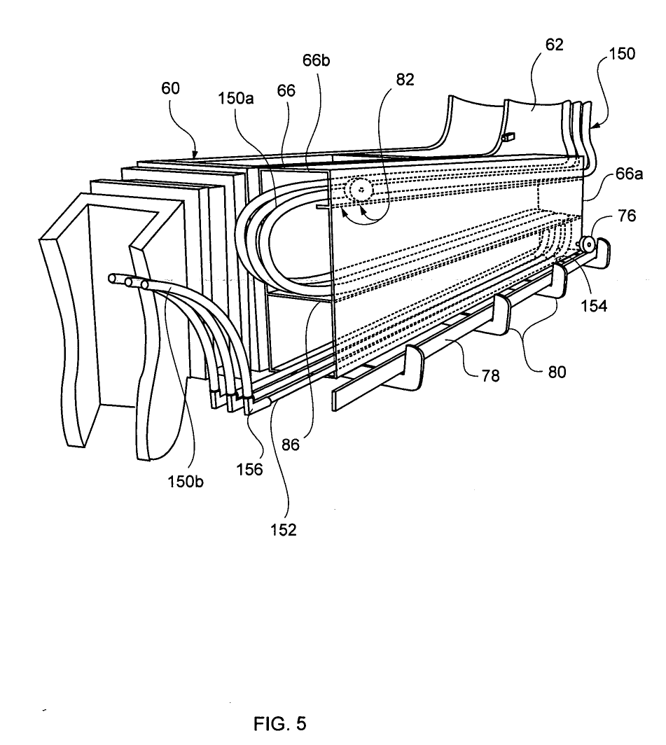

Referring generally now to FIGS. 4-5, and as described hereinabove, proximal end 62 of telescopic boom arm 60 is preferably pivotally coupled to excavator boom EB via pivot axle 65 and hydraulic cylinder 68, wherein hydraulic power for pivotal movement of boom arm 60, and thus, actuation of hydraulic cylinder 68 thereof, is preferably supplied via suitable hydraulic lines or cables extending from a conventional hydraulic power source mounted on excavator E. As more fully described below, grapple 20 is further hydraulically coupled to excavator E via hydraulic hoses or cables 150, wherein hydraulic cables 150 generally preferably extend from the conventional hydraulic power source mounted on excavator E, over excavator boom EB, over the length of boom arm 20, and to grapple 20. As such, hydraulic cables 150 preferably supply hydraulic power for the various hydraulic actuated mechanisms, movements and operations of grapple 20. However, with specific regard to boom arm 60, the requisite hydraulic power for telescopic extension and retraction of same is preferably the collective function of spring-loaded hose reels, hydraulic cables, hydraulic cylinders, and sequence valves, as more fully described below.

Telescopic boom arm 60 is preferably composed of first, second and third telescopically-engaged boom portions 70, 72, 74, respectively, wherein grapple 20 is preferably in pivotal communication with distal end 64 of boom arm 60, and more specifically, third boom portion 74. Although boom arm 60 is preferably tripartite, it should be recognized that boom arm 60 may be manufactured so as to comprise any selected number of telescopically-engaged boom portions.

Because boom arm 60 will operate between fully extended and fully retracted positions, the length of hydraulic cables 150 needed for hydraulic-actuation of grapple 20 is preferably serpentinely wrapped, coiled or otherwise folded and retained within cable housing 66; thereby, accommodating for the extension and retraction of boom arm 60. However, and as best illustrated in FIG. 5, hard-pipe hydraulic cable section 152 preferably bridges first flexible portion 150a of hydraulic cables 150 with second flexible portion 150b of hydraulic cables 150 via hard-pipe couplers 154, 156, respectively. Accordingly, first flexible portion 150a of hydraulic cables 150 preferably extends from excavator E, over excavator boom EB, through first end 66a of cable housing 66, and is secured to hard-pipe couplers 154, wherein second flexible portion 150b of hydraulic cables 150 preferably extends from hard-pipe couplers 156 disposed proximate to second end 66b of cable housing 66. Second portion 150b of hydraulic cables 150 preferably extends over third boom portion 74 and to grapple 20; thereby, providing hydraulic power to same.

With specific reference now to cable housing 66, first end 66a thereof is preferably secured, via weld and retention bars, to leading end 72a of second boom portion 72, wherein second end 66b of cable housing 66 preferably comprises wheel 76 slidably engaged and retained within guidance track 78 securely disposed on support frame 80 of first boom portion 70. As such, when boom arm 60 is in a retracted position, cable housing 66 resides substantially adjacent first boom portion 70, as best illustrated in FIG. 5. Moreover, and as further illustrated in FIG. 5, the length of flexible hydraulic cable portion 150a serpentinely wrapped or folded and disposed within cable housing 66 is further coupled to a wheel-and-track assembly 82, 84 disposed within cable housing 66 (wheel-and-track assembly 84 not shown, but disposed opposite wheel-and-track assembly 82); thereby, facilitating extension and retraction of flexible hydraulic cable portion 150a therewithin and therefrom. Further, to avoid entanglement and kinking of flexible hydraulic cable portion 150a during extension and retraction of same from cable housing 66, medial shelf 86 disposed within cable housing 66 functions to effectively elevate and, thus, separate otherwise overlapping sections or segments of flexible hydraulic cable portion 150a.

Preferably, hydraulic cylinders (not shown), disposed within second boom portion 72, assist in telescopic extension of second boom portion 72 from first boom portion 70, and, thereafter, third boom portion 74 from second boom portion 72. Specifically, hydraulic cable (not shown), carried by spring-loaded hose reels 175 disposed on first boom portion 70 (see FIG. 4), preferably supplies hydraulic power to hydraulic cylinders located within second boom portion 72 of boom 60, wherein sequence valves (not shown), residing in fluid communication with the afore-referenced hydraulic cable, preferably control the sequential extension of second boom portion 72 from first boom portion 70, and, thereafter, third boom portion 74 from second boom portion 72. The afore-referenced sequence valves further control the sequential retraction of boom arm 60. During extension of boom arm 60, spring-loaded hose reels 175 preferably enable the afore-referenced hydraulic cable wound therearound to simultaneously extend (unreel) or retract (recoil) with the respective extension or retraction of boom arm 60.

Moreover, upon telescopic extension of second boom portion 72 from first boom portion 70, cable housing 66 is preferably wheeled over guidance track 78 (i.e., as cable housing 66 is secured to leading end 72a of second boom portion 72). As best illustrated in FIG. 4, during extension of second boom portion 72 from first boom portion 70, flexible hydraulic cable portion 150a is preferably simultaneously slidably withdrawn from cable housing 66 via assistance from wheel-and-track assembly 82 thereof. Following full extension of second boom portion 72 from first boom portion 70, telescopic extension of third boom portion 74 from second boom portion 72 is preferably actuated via the afore-referenced sequence valves and hydraulic cylinders located within second boom portion 72, wherein flexible hydraulic cable portion 150b preferably contemporaneously moves with extension of third boom portion 74.

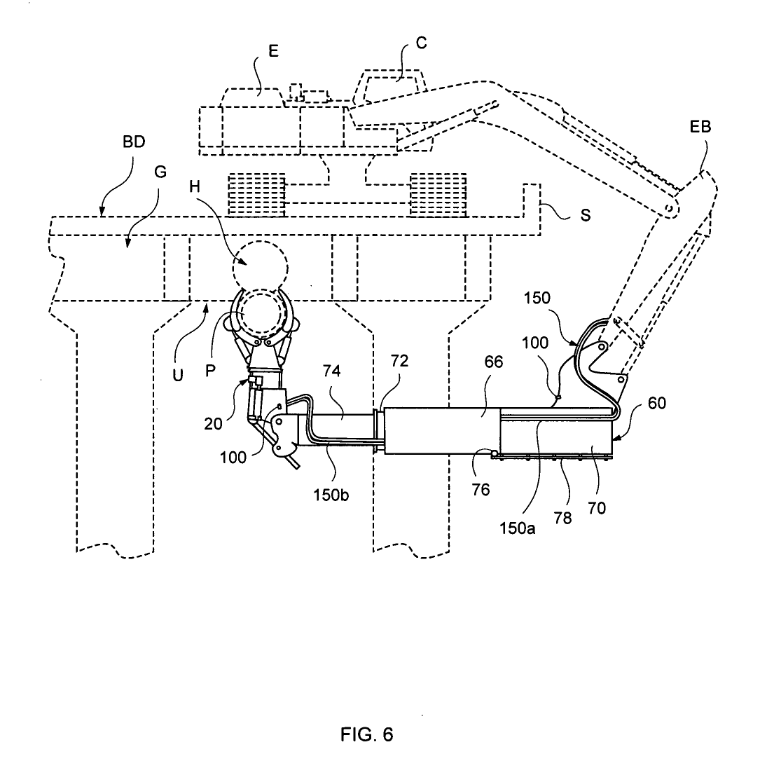

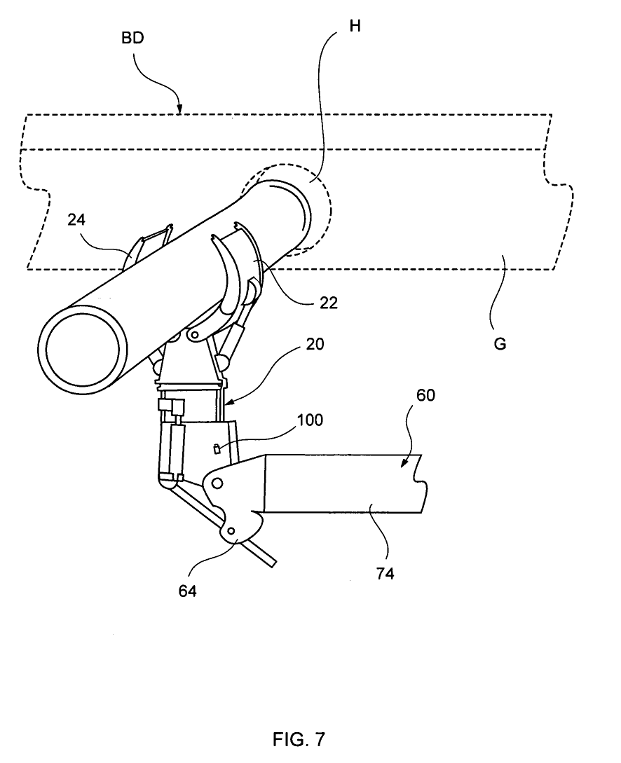

Referring now more specifically to FIGS. 6-7, with general reference to FIG. 1, in operation, upon grasping and lifting pipe P via grapple 20 of pipe-handling boom 10, the excavator/boom operator preferably maneuvers pipe-handling boom 10 to position and guide pipe P over side S of bridge deck BD. Thereafter, the excavator/boom operator preferably telescopically extends boom arm 60 out toward underside U of bridge deck BD. Once pipe P is positioned proximal to a selected pipe retaining aperture H formed through bridge girder G, the operator, through cooperative interaction of clamp jaws 22, 24, clamp jaw hydraulic cylinders 26, 28, rotation bearings 30, rotation drive 32, pivot axle 27, grapple hydraulic tilt cylinder 34, and all associated pivot joints thereof, maneuvers, rotates, cants, tilts and/or otherwise positionally-manipulates pipe P relative to hub 21 of grapple 20, and/or boom arm 60; thus, setting and/or locking pipe P into place within aperture H of girder G. Notably, the ability of grapple 20 to effectively tilt, pivot or rotate, by or within the inch, enables the excavator/boom operator to expeditiously and efficiently position, lay and secure pipe within or between girders G of bridge deck BD in a fraction of the time required through traditional pipe laying processes and equipment.

As best illustrated in FIGS. 1, 4 and 6-7, to facilitate the pipe-handling and laying process of the present invention, pipe-handling boom 10 further comprises camera assemblies 100 strategically positioned at proximal end 62 of boom arm 60, and on base 23 of grapple 20, wherein camera assemblies 100 preferably relay real-time visual feedback to television monitors (not shown) located within the operator's cab C of excavator E. As such, the operator is able to visually perceive or view all operations and movements of grapple 20, boom arm 60, and pipe-handling boom 10 generally, when extended under bridge deck BD; thereby, facilitating accuracy of the present pipe laying process. Additionally, spotters and/or other crewmen situated below bridge deck BD may provide the operator with instructional body language readily visually perceivable through camera assemblies 100 and associated television monitors within cab C of excavator E, and/or through audio communications relayed through suitable transmitters and receivers.

It is contemplated in an alternate embodiment that grapple 20 could incorporate additional pivot axles or other similar rotational joints, in conjunction with associated hydraulic cylinders, to further enhance the overall positional manipulation of a pipe P retained within clamp jaws 22, 24 thereof.

It is contemplated in another alternate embodiment that boom arm 60 could incorporate additional telescopic portions joined via pivot axles or other similar rotational joints, in conjunction with associated hydraulic cylinders, to provide boom arm 60 with enhanced structural mechanical capabilities.

It is contemplated in still another alternate embodiment that pipe-handling boom 10 could incorporate additional grapples 20.

It is contemplated in yet another alternate embodiment that pipe-handling boom 10 could incorporate additional grapples 20 capable of sliding toward each other to join pipe P held by each grapple 20.

It is contemplated in still yet another alternate embodiment that the various hydraulic cylinders and cabling of pipe-handling boom 10 could be replaced with pneumatic mechanisms and suitable cabling, other pressurized power sources, electrical power sources and cabling, and/or motive force devices.

It is contemplated in a further alternate embodiment that hydraulic cabling 150 maintained within cable housing 66 could be wound around, and released from, suitable spool-like structures.

It is contemplated in still a further alternate embodiment that pipe-handling boom 10 could be mounted onto a truck platform, rubber-tired or wheeled carriers, or any other selected mobile and stable machine, vehicle, device or platform. It is further contemplated that pipe-handling boom 10 could be integrally manufactured with an excavator boom and/or excavator.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

1. A pipe-handling boom, comprising:
a telescopically-adjustable boom arm; and,
a multi-directional grapple.

2. The pipe-handling boom of claim 1, wherein said boom arm is adapted to be pivotally mounted to a carrier, wherein the carrier is selected from the group consisting of excavator booms, excavators, vehicles, trucks, tired carriers, platforms, mobile platforms, and combinations thereof.

3. The pipe-handling boom of claim 1, wherein said boom arm is hydraulically-actuated.

4. The pipe-handling boom of claim 1, wherein said boom arm telescopically extends and retracts via hydraulic assemblies.

5. The pipe-handling boom of claim 1, wherein said boom arm is pivotally-adjustable.

6. The pipe-handling boom of claim 1, wherein said grapple is pivotally-coupled to said boom arm.

7. The pipe-handling boom of claim 1, wherein said grapple is actuated via hydraulic assemblies.

8. The pipe-handling boom of claim 7, wherein said hydraulic assemblies comprise at least a first length of hydraulic cabling maintained within a cable housing secured to at least a portion of said boom arm.

9. The pipe-handling boom of claim 8, wherein said cable housing comprises a wheel, said wheel slidably engaged and maintained within a guidance track, said guidance track carried by said boom arm.

10. The pipe-handling boom of claim 9, wherein telescopic extension of said boom arm results in said cable housing rolling over said guidance track.

11. The pipe-handling boom of claim 10, wherein telescopic extension of said boom arm results in at least a portion of said first length of hydraulic cabling being withdrawn from said cable housing.

12. The pipe-handling boom of claim 11, wherein said first length of hydraulic cabling is coupled to a wheel-and-track assembly disposed within said cable housing, wherein said wheel-and-track assembly facilitates withdrawal of at least a portion of said first length of hydraulic cabling from said cable housing upon telescopic extension of said boom arm.

13. The pipe-handling boom of claim 1, wherein said grapple is at least partially rotationally-coupled to said boom arm.

14. The pipe-handling boom of claim 13, wherein said grapple rotates via a power source, said power source selected from the group consisting of hydraulic power sources, electrical power sources, motive force devices, and combinations thereof.

15. The pipe-handling boom of claim 1, wherein said grapple comprises clamp jaws.

16. The pipe-handling boom of claim 15, wherein said clamp jaws comprise clamp jaw hydraulic cylinders, and wherein actuation of said clamp jaw hydraulic cylinders opens and closes said clamp jaws.

17. The pipe-handling boom of claim 15, wherein said clamp jaws comprise clamp jaw hydraulic cylinders, and wherein actuation of said clamp jaw hydraulic cylinders cants or tilts said clamp jaws into a selected angle relative to said boom arm.

18. The pipe-handling boom of claim 15, wherein said grapple comprises rotational bearings and a rotational drive hydraulically-actuated to enable said grapple to at least partially rotate about said boom arm.

19. The pipe-handling boom of claim 15, wherein said clamp jaws comprise slots or grooves for receiving and engaging an object.

20. The pipe-handling boom of claim 1, wherein said grapple is coupled to said boom arm via a grapple hydraulic tilt cylinder, and wherein actuation of said grapple hydraulic tilt cylinder cants or tilts said grapple into a selected angle relative to said boom arm.

21. The pipe-handling boom of claim 15, wherein said clamp jaws comprise gripping pads.

22. The pipe-handling boom of claim 1, further comprising a camera assembly, wherein said camera assembly relays visual data to a monitor.

23. A pipe-handling boom adapted to be pivotally mounted to an excavator boom of an excavator, said pipe-handing boom comprising:
a telescopically-adjustable boom arm, said boom arm pivotally and hydraulically-coupled to the excavator boom; and,
a multi-directional and fully rotational grapple, said grapple hydraulically-actuated, and pivotally-coupled to said boom arm.

24. The pipe-handling boom of claim 23, wherein said boom arm telescopically extends and retracts via hydraulic assemblies.

25. The pipe-handling boom of claim 23, wherein said grapple is rotatable about said boom arm via a power source, said power source selected from the group consisting of hydraulic power sources, electrical power sources, motive force devices, and combinations thereof.

26. The pipe-handling boom of claim 23, wherein said grapple comprises clamp jaws.

27. The pipe-handling boom of claim 26, wherein said clamp jaws comprise clamp jaw hydraulic cylinders, and wherein actuation of said clamp jaw hydraulic cylinders opens and closes said clamp jaws.

28. The pipe-handling boom of claim 26, wherein said clamp jaws comprise clamp jaw hydraulic cylinders, said clamp jaw hydraulic cylinders comprising hydraulic locking valves, and wherein said hydraulic locking valves releasably secure and clamp said clamp jaws around a selected object.

29. The pipe-handling boom of claim 26, wherein said clamp jaws comprise clamp jaw hydraulic cylinders, and wherein actuation of said clamp jaw hydraulic cylinders cants or tilts said clamp jaws into a selected angle relative to said boom arm.

30. The pipe-handling boom of claim 26, wherein said grapple comprises rotational bearings and a rotational drive hydraulically-actuated to enable said grapple to at least partially rotate about said boom arm.

31. The pipe-handling boom of claim 23, wherein said grapple is coupled to said boom arm via a grapple hydraulic tilt cylinder, and wherein actuation of said grapple hydraulic tilt cylinder cants or tilts said grapple into a selected angle relative to said boom arm.

32. A pipe-handling boom, comprising:
a multi-directional and at least partially rotatable grapple, wherein said grapple is pivotally-coupled to said pipe-handling boom, and further actuated via a power source, said power source selected from the group consisting of hydraulic power sources, electrical power sources, motive force devices, and combinations thereof.

33. The pipe-handling boom of claim 32, wherein said grapple comprises clamp jaws.

34. The pipe-handling boom of claim 33, wherein said clamp jaws comprise clamp jaw cylinders, and wherein actuation of said clamp jaw cylinders opens and closes said clamp jaws.

35. The pipe-handling boom of claim 34, wherein said clamp jaws comprise clamp jaw cylinders, said clamp jaw cylinders comprising locking valves, and wherein said locking valves releasably secure and clamp said clamp jaws around a selected object.

36. The pipe-handling boom of claim 33, wherein said clamp jaws comprise clamp jaw cylinders, and wherein actuation of said clamp jaw cylinders cants or tilts said clamp jaws into a selected angle relative to said boom arm.

37. The pipe-handling boom of claim 32, wherein said grapple comprises rotational bearings and a rotational drive actuated via said power source to enable said grapple to at least partially rotate about said pipe-handling boom.

38. The pipe-handling boom of claim 32, wherein said grapple is coupled to said pipe-handling boom via a grapple tilt cylinder, and wherein actuation of said grapple tilt cylinder cants or tilts said grapple into a selected angle relative to said pipe-handling boom.

39. A method of laying pipe into position on an underside area of a bridge deck, said method comprising the steps of:
a. positioning a pipe-handling boom atop the bridge deck; and,
b. reaching over and under the bridge deck via at least a portion of said pipe-handling boom to position the pipe on the underside area of the bridge deck.

40. The method of claim 39, further comprising the step of: c. relaying real-time video to a monitor via a camera assembly so as to provide visualization of operational parameters of said pipe-handling boom when said pipe-handling boom is at least partially disposed under the bridge deck.

41. An apparatus for laying pipe on an underside of a structure, comprising:
a. at least a portion of a structural span;
b. a carrier disposed atop said structural span, said carrier selected from the group consisting of excavator booms, excavators, vehicles, trucks, wheeled carriers, platforms, mobile platforms, and combinations thereof;
c. a pipe-handling boom, said pipe-handling boom adapted to be pivotally mounted to said carrier;
d. said pipe-handing boom comprising a telescopically-adjustable boom arm, said boom arm pivotally and hydraulically-coupled to said carrier; and,
e. said pipe-handing boom further comprising a multi-directional and fully rotational grapple, said grapple hydraulically-actuated, and pivotally-coupled to said boom arm,
wherein said pipe-handing boom enables an operator to grasp a pipe and to selectively positionally-manipulate and subsequently mount the pipe to or adjacent said underside of said structural span.

42. The apparatus of claim 41, wherein said boom arm telescopically extends and retracts via hydraulic assemblies.

43. The apparatus of claim 41, wherein said grapple is rotatable about said boom arm via a power source, said power source selected from the group consisting of hydraulic power sources, electrical power sources, motive force devices, and combinations thereof.

44. The apparatus of claim 41, wherein said grapple comprises clamp jaws.

45. The apparatus of claim 44, wherein said clamp jaws comprise clamp jaw hydraulic cylinders, and wherein actuation of said clamp jaw hydraulic cylinders opens and closes said clamp jaws.

46. The apparatus of claim 44, wherein said clamp jaws comprise clamp jaw hydraulic cylinders, said clamp jaw hydraulic cylinders comprising hydraulic locking valves, and wherein said hydraulic locking valves releasably secure and clamp said clamp jaws around a selected object.

47. The apparatus of claim 44, wherein said clamp jaws comprise clamp jaw hydraulic cylinders, and wherein actuation of said clamp jaw hydraulic cylinders cants or tilts said clamp jaws into a selected angle relative to said boom arm.

48. The apparatus of claim 44, wherein said grapple comprises rotational bearings and a rotational drive hydraulically-actuated to enable said grapple to at least partially rotate about said boom arm.

49. The apparatus of claim 41, wherein said grapple is coupled to said boom arm via a grapple hydraulic tilt cylinder, and wherein actuation of said grapple hydraulic tilt cylinder cants or tilts said grapple into a selected angle relative to said boom arm.
